(19) United States
(12) Patent Application Publication
(10) Pub. No.: US 2021/0378186 A1
(43) Pub. Date: Dec. 9, 2021

(54) Lawn Amendment and Packaging

(71) Applicant: Cindy A. HOFF, Jefferson, OR (US)

(72) Inventor: Cindy A. HOFF, Jefferson, OR (US)

(73) Assignee: Proseeds Marketing, Inc., Jefferson, OR (US)

(21) Appl. No.: 16/897,006

(22) Filed: Jun. 9, 2020

(51) Int. Cl. A01G 20/00; A01G 22/60; A01G 22/00; B65D 65/46

(52) U.S. Cl. CPC A01G 20/00; B65D 65/46; A01G 22/00; A01G 22/60

(57) ABSTRACT

Embodiments of the invention are biodegradable pods containing materials to repair damaged turf (lawns, fields). Each pod is sized and configured to repair an area ranging in size from about 9 square inches to about 36 square inches (60 cm² to 230 cm²). The pods contain granulated ingredients including fertilizer, grass seed, gypsum, humic acid and calcium, in a material that expands when moistened. The pods are covered with a water-disruptable covering such as a polyvinyl alcohol film or a biodegradable paper.

### CONTINUITY AND CLAIM OF PRIORITY

This is an original U.S. patent application.

### FIELD

The invention relates to soil amendments for lawn care. More specifically, the invention relates to ingredients and packaging suited to repair small areas of cosmetic damage that are often suffered by residential lawns.

### BACKGROUND

Many outdoor areas that are regularly maintained are planted with a low, uniform cover crop like grass or clover. These areas, which may be referred to generally as “lawns,” “turf,” “meadows” or “fields,” are often used for organized field sports (soccer, baseball, football) or general recreational purposes (running, children's play). One frequent use is for exercise and play of domestic animals, particularly dogs.

Most dogs are trained to continence, but a common purpose for “walking a dog” is to allow the dog to relieve itself out-of-doors. Besides urination and defecation, dogs “mark” locations by urinating on them. Dog urine and feces are among the most common causes of injuries suffered by lawns and fields, even though many dog owners clean up after their dogs when they might be observed.

Urine damage, in particular, tends to kill cover plants such as grass, leaving undesired brown spots. Other hazards, such as herbicide (weed killer) overspray, moles and gophers digging holes, weather conditions and insects or disease can cause similar cosmetic damage.

An easily-portable and -distributable lawn-repair substance could be of significant value to dog-walkers and others who use or care for regularly-maintained lawns and fields.

### SUMMARY

An embodiment of the invention is a self-contained “single-serving” module containing fertilizer, plant seeds and other ingredients for repairing bare and damaged spots on manicured lawns. Each module or pod contains sufficient material to treat about 15˜80 square inches (100 cm²˜500 cm²) of turf. The ingredients are held together by a biodegradable covering which deteriorates quickly under normal environmental conditions (sun, water/rain) to release the ingredients over the treatment area. Some embodiments include specific chemicals to neutralize turf-killing components of urine, so they are particularly suitable for use by dog owners cleaning up after their pets.

### BRIEF DESCRIPTION OF DRAWINGS

FIG. 1 shows a sample embodiment of the invention.

FIG. 2 shows another sample embodiment of the invention.

FIG. 3 shows a packaging system for manufacturing pods according to an embodiment.

### DETAILED DESCRIPTION

Embodiments of the invention are pre-measured, portable lawn-care pods that are easy to store, easy to carry and easy to apply without touching the pod contents. Each pod may be about 1.25 fluid ounces (37 cc) in volume, and at that size, contains about 30 g of the ingredients described below.

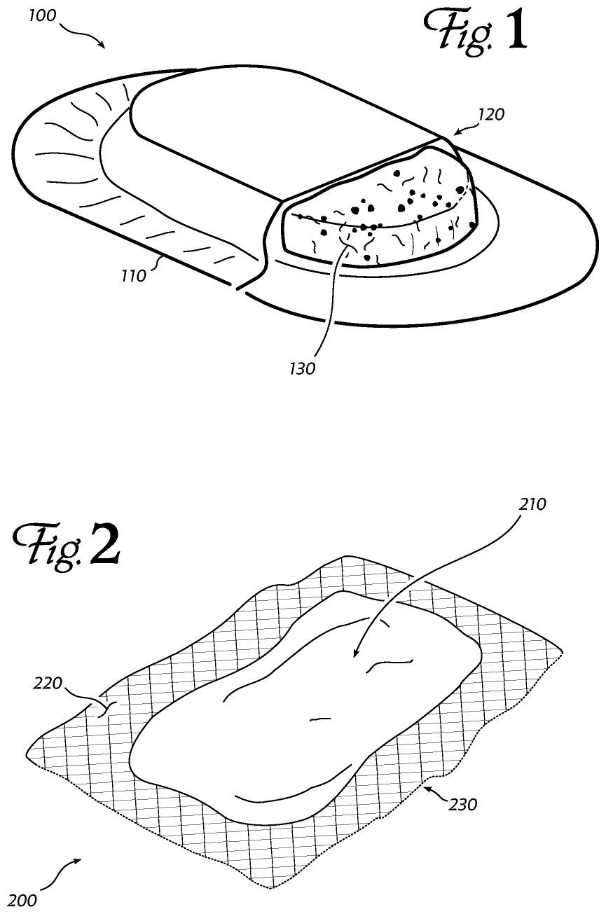

FIG. 1 shows a sample “pod” 100 according to an embodiment of the invention 100. The pod may be a relatively thin, oblong object comprising an outer covering 110, which has been partly cut away in this illustration at 120 to expose the active ingredients 130. The contents are generally granular, so they would pour out rather than retain the shape of the pod covering as shown here. The outer covering 110 is made of a biodegradable material that ruptures or deteriorates upon exposure to water. It may also be somewhat impact-sensitive, so that it can be broken open by stepping on it. When the covering is breached, the granules inside are exposed. This embodiment may be about 2″×3″ (50 cm×75 cm) and 0.5˜0.75″ (12˜19 cm) thick (volume of about 1.6˜2.0 fl. oz, 45˜60 cc).

FIG. 2 shows another sample pod 200 according to an embodiment of the invention. This may be a larger instance, for example about 3.5″×8″ (9 cm×20 cm) and about 0.5″ (1.2 cm) thick. The central portion 210 contains the active ingredients (with a volume of about 7.75 fl. Oz, 230 cc), while the cross-hatched area 220 indicates where the pod's upper and lower covering surfaces are bonded together. Pods may be made in a linear or rectangular array, with each pod separated from its neighbors by perforations through the bonded cover layers. Dashed lines 230 show where the depicted pod has been torn away from other pods in such an array.

Generally, a thin, flat pod (overall thickness 0.5″˜1.0″) is preferred over a different shape containing the same volume of ingredients.

Each pod contains a number of ingredients, many of which may be in granular form. The ingredients are mixed with a volume expander—a material that increases in volume once released or exposed from the covering. In many embodiments, the volume expander is water-activated: when moistened, the volume expander increases in size, distributing the other ingredients over a larger area. Many embodiments will use compressed coir, or coconut husk fiber, as a volume expander. This material is relatively inexpensive, tough, biodegradable, can be highly compressed, and expands well when wet. The moisture-absorbing characteristics of the volume expander are also helpful to draw moisture to the area where the pod was placed, for the benefit of plants and seeds at that location. A water-activated volume expander that absorbs at least five (5) times its weight is preferred.

The coir (or other volume expander) is mixed with ingredients chosen for their ability to repair or promote growth of turf. For example, a natural fertilizer such as chicken litter (a.k.a. dry chicken waste) is included in most embodiments. Nutri-pel, a pelletized fertilizer derived from bio-solids, is another acceptable alternative.

The inventor has also tested other fertilizers, such as soy-based granular 5-5-5 NPK fertilizer, but determined that this material did not expand well with the volume expander, and tended to mold when watered so that the grass seed did not germinate well. Chicken litter is the preferred ingredient for fertilizer, and Nutri-pel is an acceptable substitute.

Black gypsum granules with humic acid are present in many embodiments. This material is helpful to repair “burned” spots caused by animal urine. Calcium is another ingredient frequently present in an embodiment. It functions as an alkaline buffer to neutralize some acids, such as uric acid, that may be present in the soil. The calcium, gypsum and humic acid are soil improvers so they will benefit lawn growth generally, even when applied to a spot that was not damaged by urine or another cause.

Grass seeds may be mixed with the other ingredients in a pod. The seeds may be coated a hygroscopic material, micro-nutrients and microorganisms to improve germination and growth. Seed coatings can be colored, and when the colored seeds are visible through a transparent or translucent pod skin, pods with seeds for different species of turf can be distinguished.

Pods similar in form and construction to the turf-repair pods described above, but with the following differences, are also within the inventor's contemplation. Pods may be made with seeds of other plants, rather than grass or turf seeds. For example, pods containing one type, or an assortment, of flower seeds (e.g., wildflower seeds) may be useful for seeding and initial growth of a flower garden, or to add color to an existing garden with little effort. Pods containing vegetable seeds, herb seeds, or a combination thereof, can reduce the time and effort necessary to start a vegetable garden. And pods containing hemp seeds (along with the volume expander and suitable fertilizers and soil amendments) may be helpful for starting less-robust strains of those plants.

Generally, pods may be manufactured in a number of different varieties, corresponding to different species of grass or plant seeds contained therein, and different fertilizer mixes and soil amendments to suit different growing zones (c.f. United States Department of Agriculture Plant Hardiness Zone Map).

Turf-repair pods may be configured to “spot-treat” a small area of a lawn. Areas from about 9 in² to about 25 in² (60 cm² to about 160 cm²) are ideal for this treatment method. Compressed coir absorbs about ten times its weight in water, so pods containing active ingredients from about 0.75 oz. to about 7.5 oz. (about 20 g to about 150 g) are appropriate. A pod that covers a flat area of from about 9 in² to about 25 in² (60 cm² to about 160 cm²) and has a thickness of about ¼″ to ½″ (6 mm to 12 mm) is a convenient form factor for these intended uses. Smaller packages, such as spherical or oblate pods with a volume of, e.g., 5 to 20 cc, may be useful to distribute a handful at a time. These “mini” pods contain a similar volume expander mixed with fertilizer, seeds and other ingredients, surrounded by a biodegradable outer covering that ruptures on exposure to water, and which may also be mechanically broken by stepping on it.

### Pod Covering

The skin of an embodiment of the invention may be made from a biodegradable, water-soluble plastic such as polyvinyl alcohol (“PVOH,” “PVA” or “PVAI”) having a thickness of about 1.5 mil. The film has pores or small perforations that permit air exchange to help maintain seed viability. An alternate material that has been investigated is a biodegradable paper (trade name SmartSolve®, a registered trademark of CMC Group, Inc. of Bowling Green, Ohio). These materials are capable of holding the contents of a pod together securely, and releasing them upon exposure to water or mechanical stress.

### Pod Contents

A lawn repair pod according to a preferred embodiment contains:

Compressed coir (12.48 g)

Chicken litter (also known as “dry poultry waste”) (11.31 g)

Grass seed (4 g)

Black Gypsum with Humic acid (0.56 g)

Calcium (0.85 g or about 3% by weight)
Note that seeds for other plants may vary in weight; generally, sufficient number of seeds to ensure a suitable density of coverage given the germination rate and seed viability should be included.

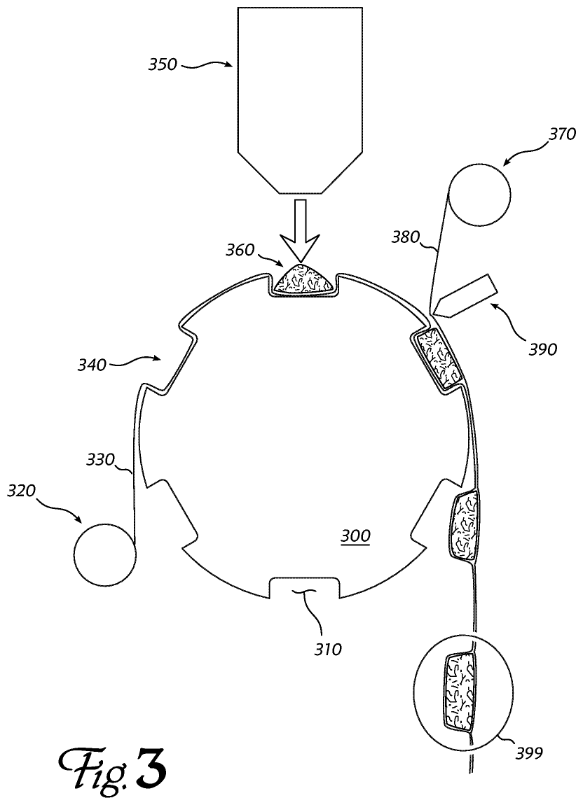

These ingredients are mixed together and then loaded into a pod covering, for example using a packaging system similar to that depicted in FIG. 3. A cylindrical drum 300 having depressions 310 formed on its surface is fitted with a vacuum apparatus to draw pod covering film 330 (e.g., PVA film) from a supply roll 320 into the depressions, as shown at 340. The drum 300 rotates to pass a hopper 350, which dispenses a suitable quantity of volume expander, fertilizer, seed and other ingredients into the film-lined depression (360). As the drum continues to rotate, another film roll 370 dispenses covering film 380, which is sealed to filled pods at 390. Finished pods 399 may be pulled from the drum 300 and severed into individual pieces, or perforated into strips or two-dimensional arrays that can be torn apart by the user.

PVA coatings are somewhat elastic, so the ingredients are slightly compressed and the coating is slightly stretched, making it easier to break open mechanically, or to breach usefully when exposed to water. The pods should be packaged in a water-resistant manner to prevent premature expansion and impairment of product quality or handling convenience.

The applications of the present invention have been described largely by reference to specific examples and in terms of particular materials and ingredients. However, those of skill in the art will recognize that turf-repair for small areas can also be accomplished by agricultural amendments that are structured or configured differently than herein described. Such variations are understood to be captured according to the following claims.

I claim:

1. A turf repair pod comprising:
a water-activated volume expander;
a granular material distributed through the volume expander so that grains of the granular material move away from each other if the volume expander is activated; and
a water-disruptable covering surrounding the volume expander and the granular material, said covering effective to prevent the volume expander from expanding until the water-disruptable covering is breached, wherein
the granular material includes at least one ingredient selected from the group consisting of:
grass seeds,
natural fertilizer,
black gypsum,
humic acid, and
calcium,
said water-activated volume expander and granular material together forming a turf-repair material.

2. The turf repair pod of claim 1, further comprising:
an effective quantity of an alkaline buffer to neutralize an acid present at a turf surface.

3. The turf repair pod of claim 1 wherein the volume expander is compressed coir.

4. The turf repair pod of claim 1 wherein the volume expander absorbs at least five (5) times its weight in water.

5. The turf repair pod of claim 1 wherein the water-disruptable covering is PVOH film.

6. The turf repair pod of claim 5 wherein the PVOH film has pores or perforations.

7. The turf repair pod of claim 1 wherein the water-disruptable covering is water-soluble paper.

8. The turf repair pod of claim 1 wherein the water-disruptable covering contains at least 10 cc of turf repair material and less than 60 cc of turf repair material.

9. The turf repair pod of claim 7 wherein the water-disruptable covering contains about 37 cc of turf repair material.

10. The turf repair pod of claim 1 having a flat area of about 40 cm² and a thickness of about 8 mm.

11. The turf repair pod of claim 1 wherein the volume expander distributes the granular material over an area of about 130 cm² when the volume expander is activated.

12. A method comprising:
mixing a plurality of materials including a water-activated volume expander and at least one ingredient selected from the group consisting of plant seeds, natural fertilizer, black gypsum, humic acid, and calcium to form a dry granulated mixture;
encapsulating the dry, granulated mixture within a water-disruptable covering to form a soil-amendment pod; and
packing a plurality of soil-amendment pods in a moisture-resistant container.

13. The method of claim 12 wherein the at least one ingredient is at least two ingredients selected from the group consisting of plant seeds, natural fertilizer, black gypsum, humic acid, and calcium.

14. The method of claim 12 wherein the plant seeds are grass seeds.

15. The method of claim 12 wherein the plant seeds are one of flower seeds, wildflower seeds, vegetable seeds, herb seeds or hemp seeds.

16. The method of claim 12 wherein each soil-amendment pod contains between 45 cc and 230 cc of the dry, granulated mixture.

17. The method of claim 12 wherein each soil-amendment pod is between 10 mm and 25 mm thick.

18. A turf repair pod comprising:
12 g of compressed coir;
11 g of dry poultry waste;
4 g of plant seeds;
0.5 g of black gypsum with humic acid; and
0.85 g of calcium, wherein
the compressed coir, dry poultry waste, plant seeds, black gypsum with humic acid and calcium are sealed into a water-disruptable covering formed from a polyvinyl alcohol (“PVA”) film having a thickness of 1.5 mil and perforations over its surface,
said turf repair pod having an overall thickness of between 10 mm and 20 mm.

19. The turf repair pod of claim 18 wherein the plant seeds are grass seeds.

20. The turf repair pod of claim 18 wherein the plant seeds are coated with a colored coating.
